(19) United States
(12) Patent Application Publication
(10) Pub. No.: US 2021/0310751 A1
(43) Pub. Date: Oct. 7, 2021

(54) HEAT CONDUCTIING DEVICE

(71) Applicant: Lenovo (Beijing) Co., Ltd., Beijing (CN)

(72) Inventors: Jun Jiao, Beijing (CN); Lianming Guo, Beijing (CN); Huajun Dong, Beijing (CN)

(21) Appl. No.: 17/207,581

(22) Filed: Mar. 19, 2021

(30) Foreign Application Priority Data
Apr. 1, 2020 (CN) 202010250268.6

(51) Int. Cl. F28F 1/40; F28D 15/04; B23P 15/26

(52) U.S. Cl. CPC F28F 1/40; F28F 2260/02; B23P 15/26; F28D 15/046

(57) ABSTRACT

The present disclosure provides a heat conducting device. The heat conducting device includes a main body, the main body including an enclosable inner cavity, the inner cavity being configured to receive a medium and accommodate the medium to carry heat to flow in the inner cavity. A surface enclosing the inner cavity is an uneven surface with a height difference, a plurality of parts of the uneven surface having the height difference, and the plurality of parts having the height difference including a plurality of microchannels for guiding the medium.

### CROSS-REFERENCES TO RELATED APPLICATION

This application claims priority to Chinese Patent Application No. 202010250268.6, entitled “Heat Conducting Device,” filed on Apr. 1, 2020, the entire content of which is incorporated herein by reference.

### FIELD OF TECHNOLOGY

The present disclosure relates to the technical field of electronic devices and, more specifically, to a heat conducting device and a processing method of the heat conducting device.

### BACKGROUND

Electronic devices such as notebook computers often use heat conducting devices to transfer the heat generated inside the electronic device to the outside of the electronic device for more timely and sufficient distribution. However, the heat conduction effect of the conventional heat conducting device is not ideal, which affects the improvement of the heat dissipation performance of the electronic device.

### BRIEF SUMMARY OF THE DISCLOSURE

One aspect of the present disclosure provides a heat conducting device. The heat conducting device includes a main body, the main body including an enclosable inner cavity, the inner cavity being configured to receive a medium and accommodate the medium to carry heat to flow in the inner cavity. A surface enclosing the inner cavity is an uneven surface with a height difference, a plurality of parts of the uneven surface having the height difference, and the plurality of parts having the height difference including a plurality of microchannels for guiding the medium.

Another aspect of the present disclosure provides a method for processing a heat conducting device. The method includes producing a main body; and processing the main body to form an uneven surface with microchannels. The main body includes an enclosable inner cavity, the inner cavity being configured to receive a medium and accommodate the medium, a surface enclosing the inner cavity being the uneven surface with a height difference, a plurality of parts of the uneven surface having the height difference, and the plurality of parts having the height difference including a plurality of microchannels for guiding the medium.

Another aspect of the present disclosure provides a computing device including a heat conducting device. The heat conducting device includes a main body, the main body including an enclosable inner cavity, the inner cavity being configured to receive a medium and accommodate the medium to carry heat to flow in the inner cavity. A surface enclosing the inner cavity is an uneven surface with a height difference, a plurality of parts of the uneven surface having the height difference, and the plurality of parts having the height difference including a plurality of microchannels for guiding the medium. The medium dissipates heat generated by the computing device through the plurality of microchannels.

### BRIEF DESCRIPTION OF THE DRAWINGS

In order to more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 is a schematic structural diagram of a main body of a first structure in a heat conducting device according to an embodiment of the present disclosure.

FIG. 2 is a cross-sectional view of the main body shown in FIG. 1.

FIG. 3 is an exploded schematic view of the main body of a second structure.

FIG. 4 is an assembly diagram of the main body shown in FIG. 3.

REFERENCE NUMERALS

| | |
|---|---|
| 1 | Main body |
| 2 | Inner cavity |
| 3 | Protrusion |
| 4 | microporous channel |
| 5 | Groove |
| 6 | Heat conduction column |
| 11 | First groove member |
| 12 | Second groove member |
| 101 | First end |
| 102 | Second end |
| 103 | First surface |
| 104 | Second surface |

### DETAILED DESCRIPTION

The present disclosure provides a heat conducting device, and the heat conduction effect of which has been significantly improved.

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

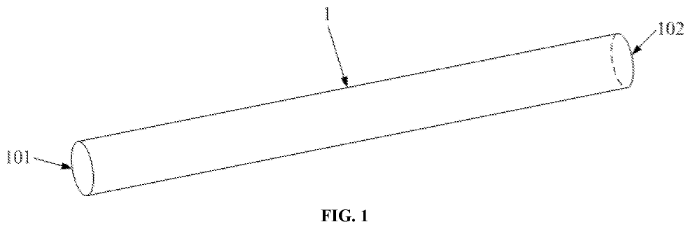

As shown in FIG. 1 to FIG. 4, embodiments of the present disclosure provide a heat conducting device, which can be installed in an electronic device such as a notebook computer to transfer heat inside the electronic device to the outside of the electronic device. The heat conducting device includes a main body 1. The main body 1 is a part that constitutes the main structure of the heat conducting device. The main body 1 includes an inner cavity 2 which can receive a medium and allow the medium to flow in it, and the medium can absorb and carry heat, and flow through the inner cavity 2 to realize the movement of heat (i.e., heat conduction). After the medium is filled into the inner cavity 2, the inner cavity 2 can be sealed to avoid the leakage of the medium. The surface of the main body 1 the encloses the inner cavity 2 may be an uneven surface, and multiple parts of the uneven surface may have height differences, that is, multiple parts of the uneven surface may be uneven. Due to the unevenness, a plurality of grooves 5 are formed on the uneven surface for the liquid medium to flow more quickly and smoothly in the inner cavity 2, such that the heat conducting device can conduct heat more efficiently. Further, microchannels can be formed on the grooves (i.e., the part with the height difference) to guide the liquid medium. The microchannel may refer to a tiny channel that can allow liquid medium to enter and flow in it. The specific structure of the microchannel can be a micropore with an inner diameter of less than 20 microns (i.e., microporous channel 4) disposed on the main body 1, and both ends of each microchannel may be directly connected to the inner cavity 2 or communicate with the inner cavity 2 by communicating with other microchannels. Since the inner diameter of the microchannel is small enough, the capillary force will have a greater impact on the medium entering the microchannel and enable to medium to flow in the microchannel under the action of the capillary force, thereby filling (in the process of filling, in some cases, it may be needed to overcome gravity) the capillary structure formed by all the microchannels. In this way, the medium can be fully dispersed in the inner cavity 2, and the maximum heat storage capacity of the heat conducting device can be increased. In addition, the specific structure of the microchannel can also be of other types. For example, the microchannel may be a strip-shaped groove opened on the concave-convex surface, and the cross-sectional shape of the strip-shaped groove can be semicircular or more than semicircular (more than semicircular may refer to the shape formed by an arc longer than the semicircle and shorter than the full circle), and its inner diameter may also be less than 20 microns.

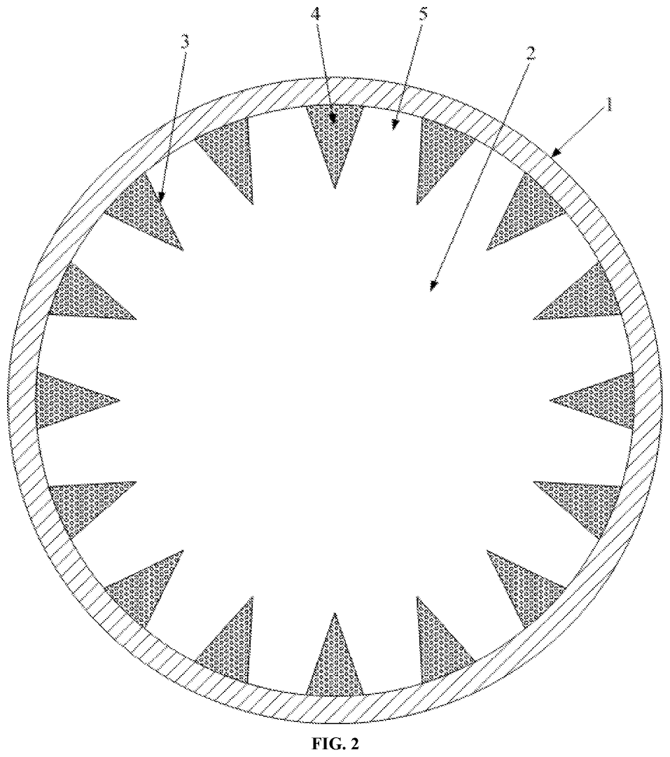

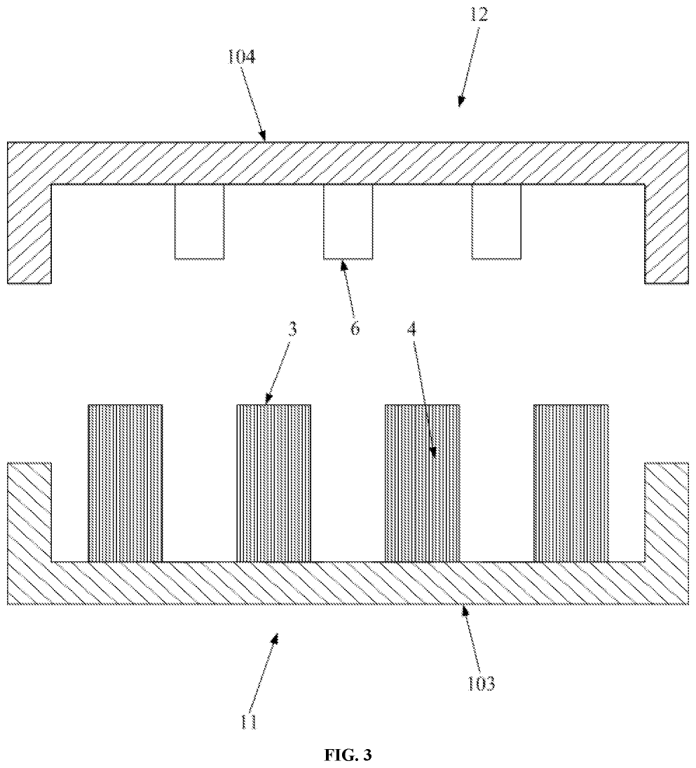

In the above structure, in the multiple different parts of the uneven surface with height differences as shown in FIG. 2 and FIG. 3, the height difference of each part can be completely the same, partly the same, or different. That is, the protrusion height of each part relative to the inner wall of the main body 1 may be all the same, partly the same, or different, such that the depth of the groove formed at different parts can be different, and the performance of the liquid medium at different parts of the groove can be different. For example, as one end of groove is approaching the main body 1, the performance of guiding the medium at different parts of the groove can be increased, such that the flow of the medium can be smoother. At the same time, in the parts with height differences, microchannels can be formed on each part or some parts to meet the different heat conduction requirements of different installation needs. For example, when the medium only flows horizontally, the medium may be positioned in the lower half of the inner cavity 2, such that microchannels may be formed on the uneven surface that encloses the lower half of the space, and no microchannels may be formed on the upper half of the inner cavity 2 that does not contact the medium. In this way, the processing procedure of the main body 1 can be simplified, and the processing workload can be reduced. In another example, when the medium flows obliquely (i.e., when there is height difference between the two parts that the medium needs to reach), if the medium flows in the inner cavity 2, it may come into contact with various parts of the uneven surface enclosing the inner cavity 2, therefore, it may be needed to form the microchannels in each part.

In the structure of the heat conducting device described above, the surface enclosing the inner cavity 2 can be an uneven surface, thereby forming grooves 5 for the medium to flow, such that the medium can flow in the inner cavity 2 more quickly and smoothly. Further, microchannels can also be formed in the uneven surface of the grooves 5, such that the capillary structure can be formed in this position. That is, the grooves 5 described above can be enclosed by the capillary structure, such that when the medium flows in the grooves 5, the capillary structure formed by the microchannels can increase the maximum heat storage of the heat conducting device. In this way, the heat conducting device can have both the advantages of good fluidity of the grooves 5 and the advantages of larger heat storage capacity of the capillary structure, and through these optimizations, the heat conducting effect of the heat conducting device can be significantly improved. Moreover, since the depth of the groove 5 and the size of the inner cavity 2 are different, that is, the size of the groove 5 is also small, the flow of the medium in the groove 5 may also have the effect of capillary force. In addition, since microchannels are arranged in the grooves 5, when the medium flows in the grooves, it is also flowing in the microchannels, such that the medium can be subjected to both the capillary force of the grooves and the capillary force of the microchannels when flowing. These two capillary forces can promote each other, such that the total capillary force of the medium is not only greater than the capillary force of the individual grooves and the capillary force of the microchannels, but also greater than the sum of the capillary force of the grooves and the capillary force of the microchannels. As a result, the flow of the medium can be more smooth than the medium flowing only in the grooves, only in the capillary structure, and only in the structure composed on alternating grooves and capillary structures, such that the heat conducing effect of the heat conducting device can be further improved.

In this embodiment, the closed cavity 2 of the heat conducting device can be filled with a medium, that is, the heat conducting device may include the main body 1 and the medium. The medium can flow in the inner cavity 2 to realize the transfer of heat between different parts of the main body 1. The heat conduction principle of the heat conducting device provided in the present disclosure is as follow. A first part of the main body 1 may contact a high-temperature part, and a second part of the main body 1 may contact a low-temperature part, such that the main body 1 can transfer (or conduct) heat for the high-temperature part to the low-temperature part. Alternatively, the first part of the main body 1 may be positioned in a high-temperature environment, and the second part of the main body 1 may be positioned in a low-temperature environment, such that the main body 1 can transfer the heat in the high-temperature environment to the low-temperature environment. The medium filled in the inner cavity 2 may be liquid when it does not absorb heat (i.e., the medium at room temperature maybe liquid). When the heat from the high-temperature part or the high-temperature environment enters the inner cavity 2 from the first part, the medium positioned in the first part can absorb the heat. Due to heat absorption, the medium may change from liquid to gas, and then the gaseous medium carrying heat may drift in the inner cavity 2 and move to the second part. At this time, the heat is transferred between the first part and the second part, and then the second part can absorb the heat carried by the medium and allow the heat to enter the low-temperature part or the low-temperature environment. Due to heat release, the medium in the second part may change from a gaseous state to a liquid state again, and then the liquid medium may flow back to the first part through the capillary structure formed by the grooves and the microchannels (when the height of the high-temperature part is greater than the height of the low-temperature part, the return direction of the liquid medium may be upward, such that the medium may need to overcome gravity during the flow process). In this way, the medium completes a cycle in the cavity 2, and then the medium can repeat the above process to start the next cycle.

The main body 1 may have various structures. As shown in FIG. 1 and FIG. 2, in a first structure, the main body 1 can be a tubular member. Of the two ends of the tubular member, a first end 101 (i.e., the first part described above) may be in contact with a heating element (i.e., the high-temperature part described above), and a second end 102 opposite to the first end 101 (i.e., the second part described above) may be in contact with the a heat dissipation element (i.e., the low-temperature part described above). The medium may circulate between the first end 101 and the second end 102 to transfer heat from the first end 101 to the second end 102. In some embodiments, the heating element may be an electronic device, such as a CPU, etc. arranged inside the housing of the electronic device. When the tubular main body 1 is disposed on the electronic device, its first end 101 may extend into the inside of the electronic device and contact the electronic components, and the second end 102 may extend to the outside of the housing of the electronic device. During the operation of the electronic device, the heat generated by the electronic device can be conducted to the first end 101 of the main body 1, and be absorbed by the medium. Subsequently, the heat can be transferred to the second end 102 through the transfer process described above, and the heat can be transferred to the heat dissipation element (e.g., heat sink fins) at the second end 102, and the heat dissipation element can dissipate heat to the environment outside the electronic device to realize the heat dissipation of the electronic device.

When the main body 1 is a tubular member, as shown in FIG. 2, a plurality of protrusions 3 protruding from the inner wall are connected to the inner wall of the tubular member. The surface of the inner wall of the tubular member and the surface of the protrusion 3 constitute the uneven surface described above, and there is a height difference between the protruding end of the protrusion 3 and the inner wall of the tubular member. That is, in the first structure, the method of forming the surface enclosing the inner cavity 2 as an uneven surface may include providing a plurality of protrusions 3 on the inner wall of the tubular member that protrude relative to the inner wall. At this time, the part of the surface not covered by the plurality of protrusions 3 and the surface of the plurality of protrusion 3 together form the uneven surface. That is, the surface of the protrusion 3 is convex relative to the surface of the inner wall, and the surface of the inner wall is concave relative to the surface of the protrusion 3, and the height difference of the protrusion 3 may refer to the difference of the protrusion 3 protruding from the inner wall. In this way, the uneven surface can be formed is the tubular member, which is beneficial to the simultaneous formation of microchannels (explained in the following description). In addition, the uneven surface can also be formed by processing the inner wall of the tubular member (e.g., by cutting, thermoforming, etching, etc.).

In some embodiments, the protrusions 3 may be solid members composed of metal powder (the material of the metal powder can be copper, aluminum, stainless steel, etc.), such that the protrusions 3 can have the microporous channels 4. There are many method of forming the protrusions 3. In some embodiments, the protrusions 3 are formed by using metal powders because after a large number of powder particles are aggregated, there will be gaps between the powder particles, and these gaps constitute the microporous channels 4. In this way, while the protrusions 3 are being formed, the microporous channels 4 can be formed at the same time, such that there is no need to perform a special processing operation to form the microporous channels 4, thereby simplifying the processing operation. In addition, since the gaps between the powder particles are disordered and interconnected, the capillary structure formed based on the gaps can better guide the medium and increase the maximum heat storage of the heat conducting device.

In this embodiment, the protrusion 3 may be a strip-shaped member extending along the axial direction of the tubular member, and a plurality of protrusions 3 can be spaced part in the circumferential direction of the tubular member, such that any two adjacent protrusions 3 and the inner wall of the tubular member can enclose a groove 5 for guiding the medium, as shown in FIG. 2. As mentioned above, the medium needs to flow from one end of the tubular member to the other end during the recirculation process. Therefore, the protrusions 3 that guide the flow of the medium needs to extend uninterruptedly along the axial direction of the tubular member as a whole. For this reason, the protrusion 3 can be a strip-shaped member. Based on this, a plurality of protrusions 3 can be spaced apart in the circumferential direction of the tubular member to enclose the groove 5, such that the returning medium can flow in the groove 5. In addition, since the side wall of the groove 5 can be composed of protrusions 3 having microporous channels 4, when the medium flows in the groove 5, it can not only achieve a fast and smooth flow through the guidance of the groove 5, but also can enter the microporous channels 4 and achieve the increase of the maximum heat storage through the capillary structure formed by the microporous channels 4.

On the basis that the protrusions 3 extend along the axial direction of the tubular member as a whole, there are also many options for the arrangement of the protrusions 3 on the inner wall of the tubular member. For example, as shown in FIG. 2, the strip-shaped protrusions 3 are extending parallel to the axis of the tubular member, such that the grooves 5 can be parallel grooves 5 parallel to the tubular member. That is, the groove 5 can connect the first end 101 and the second end 102 of the tubular member along a straight line, thereby reducing the return path of the medium and allowing the medium to return more quickly. Alternatively, the strip-shaped protrusions 3 can also extend around the axis of the tubular member, such that the grooves 5 can be spiral grooves 5 around the axis of the tubular member. That is, the grooves 5 can continue in a spiral shape, such that the medium can be better dispersed on the inner wall of the tubular member, and the maximum heat storage of the heat conducting device can be increased.

In addition, on the premise that the normal flow of the medium can be ensured, the protrusions 3 may also have shapes other than the strip structure. For example, the protrusion 3 may be a cylindrical or conical member protruding from the inner wall of the tubular member, and a plurality of cylindrical or conical members can be distributed on the inner wall of the tubular member discretely, in a matrix, or randomly distributed.

Based on the above description, on the premise that the groove 5 can be normally enclosed, the cross-sectional shape of the protrusion 3 can also have a variety of choices, such as the triangle shown in FIG. 1, or it may also be rectangular, trapezoidal, semicircular, etc.

As shown in FIG. 2, the inner wall of the tubular member can be a smooth inner wall, and the smoother inner wall can be the bottom wall of the groove 5. That is, the inner wall of the tubular member is not an uneven wall surface. Before the protrusions 3 are set, the inner wall of the tubular member can be smooth, and the uneven surface can be formed by the protrusions 3. After the protrusions 3 are set, the smooth inner wall can be directly used as the bottom wall of the groove 5. The advantage of this arrangement is that in the radial direction of the tubular member, there is only the component of the tubular member in the position corresponding to the groove 5, and no other structure is arranged. In this way, the wall thickness of the tubular member is relatively thin, and the thermal resistance can be reduced. Therefore, in the process of heat transfer, a part of the heat in the inner cavity 2 can be easily radiated directly through the radial heat transfer of the tubular member, that is, the main body 1 can have a good heat dissipation effect, which can further improve the heat dissipation performance of the electronic device. In addition, the inner wall of the tubular may not be a smooth inner wall. For example, a plurality of recessed grooves may be provided on the inner wall of the tubular member at intervals, and the recessed grooves and the groove 5 may be arranged with a one-to-one correspondence. That is, each recessed groove can be positioned at the bottom of a groove 5, such that the recessed groove can become a component of the groove 5, such that while further improving the guidance performance of the groove 5, the wall thickness of the tubular member can be further reduced thereby further improving the heat dissipation effect of the heat conducting device.

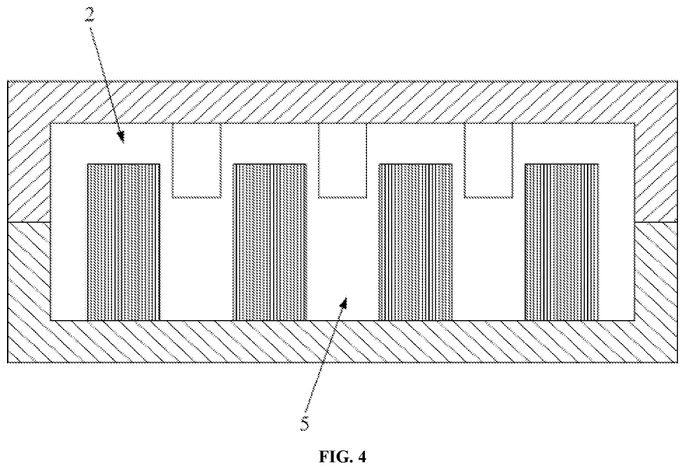

In addition, as shown in FIG. 3 and FIG. 4, in some embodiments, the main body 1 can be a plate-shaped member. That is, the main body 1 can have a first surface 103 and a second surface 104 disposed opposite to each other. The first surface 103 (i.e., the first part described above) may be a heat generation contact surface that is in contact with the heating element (i.e., the high-temperature part described above), and the second surface 104 (i.e., the second part described above) may be a heat dissipation contact surface that is in contact with the heat dissipation element (i.e., the low-temperature part described above). The medium can circulate between the first end 101 and the second end 102 to transfer heat from the heat generation contact surface to the heat dissipation contact surface. When the heat conducting device of this structure is installed in electronic device, it can be completely positioned inside the housing of the electronic device, and the first surface 103 can also be in contact with the heating electronic device, while the second surface 104 can be in contact with the heat dissipation system of the electronic device. During the operation of the electronic device, the heat generated by the electronic device can be conducted to the first surface 103 and absorbed by the medium. Through the transfer process described above, the heat can be transfer to the second surface 104 and the heat can be evenly distributed on the second surface 104. Subsequently, the heat on the second surface 104 can be transferred to the heat dissipation system, and the heat can be dissipated to the environment outside the electronic device through the heat dissipation system, thereby realizing the heat dissipation of the electronic device.

As shown in FIG. 3 and FIG. 4, the plate-shaped main body 1 includes a first groove member 11 with a first surface 103, and a second groove member 12 with the second surface 104. The first groove member 11 and the second groove member 12 enclose the inner cavity 2. In some embodiments, the groove spaces of the first groove member 11 and the second groove member 12 may both be part of the inner cavity 2. When the first groove member 11 and the second groove member 12 are connected together, the groove space of the first groove member 11 and the groove space second groove member 12 can combine into the second groove member 12. The first surface 103 and the second surface 104 can be respectively the two outer surfaces that have the largest area of the plate-shaped structure formed after the connection and can be arrange opposite to each other. The main body 1 composed of the first groove member 11 and the second groove member 12 has a simple structure and is convenient for molding. In addition, the plate-shaped main body 1 may also have other structures, such as a narrowing groove disposed on the vertical side wall of the plate-shaped solid member as a whole, and the size of the inner space of the narrowing groove may be close to the size of the solid member. In this way, the inner space can be the inner cavity 2 containing the medium, and a blocking member capable of blocking the opening can be disposed at the opening of the narrowing groove.

More specifically, as shown in FIG. 3, a plurality of protrusions 3 are disposed on the bottom wall of the groove of the first groove member 11. The surface of the bottom wall of the groove and the surface of the protrusion 3 constitute the uneven surface described above, and there is a height difference between the protruding end of the protrusion 3 and the inner wall of the groove. That is, in the second structure, the method of forming the uneven surface of the surface enclosing the inner cavity 2 may be to provide a protrusion 3 protruding from the bottom wall of the groove on the bottom wall of the groove of the first groove member 11. At this time, the partial surface of the bottom wall of the groove that is not covered by the protrusion 3 and the surface of the protrusion 3 together form an uneven surface. That is, the surface of the protrusion 3 may be convex relative to the surface of the bottom wall of the groove, the surface of the groove bottom wall may be concave relative to the surface of the protrusion 3, and the height difference of the uneven surface may refer to the difference between the protrusion 3 protruding from the bottom wall of the groove. In some embodiments, in order to better realize the reflux and heat absorption of the liquid, the protruding end of the protrusion 3 provided on the first groove member 11 may be close to the bottom wall of the groove of the second groove member 12 or directly contact the bottom wall of the groove of the second groove member 12, as shown in FIG. 4.

In some embodiments, the protrusion 3 and the first groove member 11 may be an integral structure. The protrusions 3 can be formed using an etching method that will be described later, and the microporous channels 4 on the protrusions 3 can be processed using a special processing, such as the micro-electromechanical processing that will be described later. Compared with the capillary structure composed of fibers or net-like wicks arranged in the inner cavity 2, by making the protrusions 3 and the first groove member 11 as an integral structure and forming a capillary structure by opening holes on the protrusions 3 can reduce the space occupied by the capillary structure while achieving the same effect. That is, the size of the protrusions 3 can be smaller than the size of the fiber or net-like wicks, such that the space of the inner cavity 2 can be reduced. As such, the wall thickness of the ultra-thin heat-conducting device with a certain thickness (the thickness of the ultra-thin heat-conducting device is generally 0.4 mm) can be increased. For example, when the wall thickness of the first groove member 11 remains unchanged, the wall thickness of the second groove member 12 (this wall may refer to the wall where the second surface 104 is positioned) can be increased from the from less than 0.1 mm to less than 0.2 mm, thereby improving the structural strength of the entire heat conducting device, and extending the service life of the heat conducting device.

As shown in FIG. 3 and FIG. 4, in this embodiment, all the microporous channels 4 formed on the first groove member 11 by using the micro-electromechanical processing are linear channels. Further, on the basis that the microporous channels 4 are all linear channels, in some embodiments, all the microporous channels 4 may be arranged in parallel, and perpendicular to the bottom wall of the groove of the first groove member 11. The microporous channels 4 of this structure is not only convenient for processing, but can also reduce the reflux path of the medium, making the medium flow back quickly, thereby improving the heat conduction effect of the heat conducting device. In addition, under the premise that the microporous channels 4 can be formed normally, the microporous channels 4 may also be bent channels.

As shown in FIG. 3, in some embodiments, a plurality of heat conduction columns 6 are disposed on the bottom wall of the groove of the second groove member 12, and the heat conduction columns 6 are distributed in a matrix on the bottom wall of the groove. The arrangement of the heat conduction columns 6 can further increase the structural strength of the plate-shaped heat conducting device, reduce the probability of deformation of the inner cavity 2, such that the heat conducting device can perform heat conduction more safely and reliably. Further, the heat conduction columns 6 also have a heat conduction function, which can also play a certain role in the transfer of heat between the first surface 103 and the second surface 104.

Based on the heat conducting device described above, an embodiment of the present disclosure further provides a processing method of the heat conducting device. The processing method will be described below.

The main body 1 can be obtained by processing, and the main body 1 can be processed and formed by using conventional technologies.

An uneven surface having microchannels can be processed and formed on the main body 1. That is, groove 5 and microchannels can be formed on the main body 1. In some embodiments, the processed main body 1 can have an inner cavity 2 that can be closed, and the inner cavity 2 can contain the medium and enable the medium to flow in the inner cavity 2. In some embodiments, the surface enclosing the inner cavity 2 may be the uneven surface with a height difference described above, and the height differences can be arranged at multiple positions of the uneven surface. The microchannels for guiding the medium can be arrange at the positions with the height difference to obtain the heat conducting device described above.

In the processes described above, there are many options for the formation of the uneven surface and the microchannels. The uneven surface can be formed on the main body 1 first, and then the microchannels can be formed on the uneven surface. Or, while forming the uneven surface on the main body 1, the microchannels can be simultaneously formed on the uneven surface. For example, the main body 1 may adopt the method of forming the heat conducting device of the first structure described above. Or, microchannels can be formed on the protrusion 3, and then the protrusion 3 with the microchannels can be disposed on the main body 1 to form an uneven surface. That is, the independent protrusion 3 can be processed first, and then the microporous channels 4 can be processed on the protrusion 3, and then the protrusion 3 can be assembled to the main body 1. In the three methods described above, when the uneven surface is formed before the microchannels, the microchannels can be formed after the uneven surface has been formed, such that the microchannels can be processed more accurately on the uneven surface, making the processing precision of the microchannels higher. When the uneven surface and the microchannels are formed at the same time, the formation of the uneven surface and the microchannels can be realized through one operation, which simplifies the processing procedures and makes the processing of the heat conducting device simpler and more convenient. When the microchannels are formed before the uneven surface, the processing and formation of the microchannels can be realized outside the main body 1, thereby avoiding the limitation of the main body 1 for the processing of the microchannels, making the formation operation of the microchannels more convenient.

More specifically, the processing method of the heat conducting device of the main body 1 of the first structure may include obtaining the tubular main body 1 through processing; inserting a molding die (the molding die may be a round bar with grooves on the outer peripheral surface) into the tubular main body 1, there may be a gap between the forming mold and the inner wall of the tubular member the contour of the gap being the contour of the protrusion 3; filling the gap with metal powder and ensuring that the metal powder fills the gap; sintering the metal powder (the main body 1 and the molding die can be heated together) to obtain the protrusions 3 with microchannels connected to the inner wall of the main body 1 such that the surface of the main body 1 forms an uneven surface; and filling the inner cavity 2 with a medium and blocking the openings at both ends of the main body 1 to form an enclosed inner cavity 2.

The processing method of the heat conducting device of the main body 1 of the first structure may include obtaining a plate-shaped main body 1 through processing, that is, obtaining the plate-shaped first part and second part through processing; and etching the main body 1 to obtain the protrusions 3 connected to the main body 1 to form an uneven surface on the main body 1, that is, etching a plurality of parts of the first part and the second part to form a first groove member 11 with a raised portion on the bottom wall of the groove. That is, when the first groove member 11 is formed, the uneven surface formed by the surface of the bottom wall of the groove and the surface of the protrusion can also be formed. A second groove member 12 can form the second part, and the heat conduction columns 6 described above can also be formed at the same time as the second groove member 12 is formed. The processing method further includes using micro-electromechanical processing (MEME) to process and form microchannels on the protrusion 3. That is, forming the microporous channels 4 on the protrusion by using micro-electromechanical processing, such that the raised portion becomes the protrusion 3. The processing method further includes connecting and bonding the first groove member 11 and the second groove member 12 to form an enclosed inner cavity 2.

Various embodiments of the present specification are described in a progressive manner. The structure of each part focuses on the difference from the conventional technology. The overall and partial structure of the heat conducting device can be obtained by combining the structure of multiple parts described above.

The above specification that discloses various embodiments in intended for those skilled in the art to practice or use the present disclosure. Various modifications of these embodiments are apparent to those skilled in the art, and the basic principles defined in this paper can be realized in other embodiments without departing, from the spirit or scope of this invention. As such, the present disclosure will not be limited to the disclosed embodiments, but rather it is intended to satisfy the widest range that is consistent with the principles and novel ideas made common by the present disclosure.

What is claimed is:

1. A heat conducting device, comprising:
a main body, the main body including an enclosable inner cavity, the inner cavity being configured to receive a medium and accommodate the medium to carry heat to flow in the inner cavity, wherein
a surface enclosing the inner cavity is an uneven surface with a height difference, a plurality of parts of the uneven surface having the height difference, and the plurality of parts having the height difference including a plurality of microchannels for guiding the medium.

2. The heat conducting device of claim 1, wherein:
the main body is a tubular member, a first end of the tubular member being in contact with a heating element, a second end of the tubular member opposite tot eh first end being in contact with a heat dissipation element, the medium circulating between the first end and the second end to transfer heat from the first end to the second end; and
an inner wall of the tubular member is connected with a plurality of protrusions protruding from the inner wall, surface of the inner wall of the tubular member and surfaces of the plurality of protrusions constituting the uneven surface, a protruding end of the protrusion and the inner wall of the tubular member including the height difference.

3. The heat conducting device of claim 2, wherein:
the protrusion is a solid member composed of metal powder for forming microporous channels on the protrusion.

4. The heat conducting device of claim 2, wherein:
the protrusion is a strip-shaped member extending along an axial direction of the tubular member, and a plurality of protrusions are distributed at intervals in a circumferential direction of the tubular member for two adjacent protrusions and the inner wall of the tubular member to form a groove for guiding the medium.

5. The heat conducting device of claim 4, wherein:
the strip-shaped protrusions extend parallel to an axis of the tubular member for the groove to be a parallel groove parallel to the tubular member;

6. The heat conducting device of claim 4, wherein:
the strip-shaped protrusions extend around the axis of the tubular member for the groove to be a spiral groove around the axis of the tubular member.

7. The heat conducting device of claim 1, wherein:
the main body includes a first surface and a second surface opposite to each other, the first surface being a heat generation contact surface in contact with the heating element, the second surface being a heat dissipation contact surface in contact with the heat dissipation element, the medium circulating between the first surface and the second surface to transfer heat from the heat generation contact surface to the heat dissipation contact surface.

8. The heat conducting device of claim 7, wherein:
the main body includes a first groove member having the first surface and a second groove member having the second surface, the first groove member and the second groove member enclosing the inner cavity; and
the plurality of protrusions are disposed on a bottom wall of a groove of the first groove member, a surface of the bottom wall of the groove and surface of the plurality of protrusions constitute the uneven surface, the protruding end of the protrusion and the inner wall of the groove including the height difference

9. A method for processing a heat conducting device, comprising:
producing a main body; and
processing the main body to form an uneven surface with microchannels, wherein
the main body includes an enclosable inner cavity, the inner cavity being configured to receive a medium and accommodate the medium, a surface enclosing the inner cavity being the uneven surface with a height difference, a plurality of parts of the uneven surface having the height difference, and the plurality of parts having the height difference including a plurality of microchannels for guiding the medium.

10. The method of claim 9, wherein:
the uneven surface is formed on the main body before forming the microchannels on the uneven surface.

11. The method of claim 9, wherein:
the uneven surface is formed on the main body while forming the microchannels on the uneven surface

12. The method of claim 9, wherein:
the microchannels are formed on a plurality of protrusions before disposing the plurality of protrusions with the microchannels on the main body to form the uneven surface.

13. The method of claim 12, further comprising:
processing to obtain a tubular main body; and
sintering metal powder to obtain the plurality of protrusions having the microchannels connected to the main body to form the uneven surface on the surface of the main body.

14. The method of claim 12, further comprising:
processing to obtain a plate-shaped main body;
etching the main body to obtain the plurality of protrusions connected to the main body to form the uneven surface on the main body; and
using micro-electromechanical processing to form microchannels on the plurality of protrusions.

15. A computing device including a heat conducting device, the heat conducting device comprising:
a main body, the main body including an enclosable inner cavity, the inner cavity being configured to receive a medium and accommodate the medium to carry heat to flow in the inner cavity, wherein
a surface enclosing the inner cavity is an uneven surface with a height difference, a plurality of parts of the uneven surface having the height difference, and the plurality of parts having the height difference including a plurality of microchannels for guiding the medium, and
the medium dissipates heat generated by the computing device through the plurality of microchannels.

16. The computing device of claim 15, wherein:
the main body of the heat conducting device is a tubular member, a first end of the tubular member being in contact with a heating element, a second end of the tubular member opposite tot eh first end being in contact with a heat dissipation element, the medium circulating between the first end and the second end to transfer heat from the first end to the second end; and
an inner wall of the tubular member is connected with a plurality of protrusions protruding from the inner wall, surface of the inner wall of the tubular member and surfaces of the plurality of protrusions constituting the uneven surface, a protruding end of the protrusion and the inner wall of the tubular member including the height difference.

17. The computing device of claim 16, wherein:
the protrusion is a solid member composed of metal powder for forming microporous channels on the protrusion.

18. The computing device of claim 16, wherein:
the protrusion is a strip-shaped member extending along an axial direction of the tubular member, and a plurality of protrusions are distributed at intervals in a circumferential direction of the tubular member for two adjacent protrusions and the inner wall of the tubular member to form a groove for guiding the medium.

19. The computing device of claim 16, wherein the main body of the heat conducting device is a part of a bottom plate of the computing device.

20. The computing device of claim 16, wherein the main body of the heat conducting device is a part of a top plate of the computing device.
